(19) United States
(12) Patent Application Publication
(10) Pub. No.: US 2023/0079431 A1
(43) Pub. Date: Mar. 16, 2023

(54) SOLID MODELING AND NON-FUNGIBLE VIRTUAL AND ANTI-COUNTERFEITING INTEGRATION SYSTEM

(71) Applicants: JUAN-HUNG WU, New Taipei (TW); PO-HUAN LEE, New Taipei (TW); YU-MING CHANG, New Taipei (TW)

(72) Inventors: JUAN-HUNG WU, New Taipei (TW); PO-HUAN LEE, New Taipei (TW); YU-MING CHANG, New Taipei (TW)

(73) Assignee: M-ONE INC., New Taipei (TW)

(21) Appl. No.: 17/473,772

(22) Filed: Sep. 13, 2021

(51) Int. Cl. H04L 9/32; H04L 9/30; H04L 9/08; H04L 9/14; G06T 17/10

(52) U.S. Cl. CPC H04L 9/3236; H04L 9/3073; H04L 9/0897; H04L 9/14; H04L 9/321; G06T 17/10

(57) ABSTRACT

A solid modeling and non-fungible virtual and anti-counterfeiting integration system mainly comprises a 3D modeling device, an elliptic curve cryptographic module, and a non-fungible transaction platform. The 3D modeling device mainly obtains a 3D image file with a characteristic value from a physical object, the elliptic curve cryptographic module generates a sub-public key and a sub-private key, and the non-fungible transaction platform comprises a master private key and a master public key. The sub-public key is capable of encrypting the characteristic value, the sub-private key decrypts the sub-public key to restore the characteristic value and display the 3D image file, the master private key signs the sub-public key and the sub-private key, the master public key verifies the signature, by obtaining the sub-public key and the sub-private key, the sub-private key is capable of decrypting the sub-public key to restore the characteristic value and display the 3D image file.

### BACKGROUND OF THE INVENTION

### Field of Invention

The invention is a non-fungible token (NFT) application, and more particularly a solid modeling and non-fungible virtual and anti-counterfeiting integration system.

### Related Art

The ownership and transaction of valuable assets on the market, such as antiques, artworks or collectibles, have always been a symbol of wealth and status in society. Due to the high value of such assets and the fact that they are usually indivisible physically, ordinary people can not invest in such assets. In addition, higher-value assets usually have high knowledge content, and buyers must have a certain degree of knowledge of such valuable assets before investing, such as distinguishing authentic and counterfeit products or evaluating the market value of commodities.

As for collectors who do not meet the above conditions, they are not qualified in the current market mechanism and even not equipped with the basic conditions for acquisition. Therefore, how to enable such collectors to enjoy legal appreciating right is a problem that the invention intends to solve.

### SUMMARY OF THE INVENTION

A main object of the invention is to construct a 3D image file of a physical object (antiques, masterpieces in painting, etc.) with high economic value by using a 3D modeling device, and then employ an elliptic curve cryptographic module to encrypt and decrypt a characteristic value of the 3D image file with a sub-public key and a sub-private key by using encryption algorithm. The encrypted 3D image file is bidden on a non-fungible transaction platform, a successful bidder is capable of using a master private key and a master public key of the non-fungible transaction platform for signing and authentication to ensure that the owner successful in bidding is capable of owning a non-fungible virtual appreciating right of the physical object. Through the non-fungible transaction platform mechanism, the possibility of plagiarism and misappropriation is also educed. Furthermore, through a non-fungible token (NFT) method, buyers can collect a digital copy of the physical object from the non-fungible transaction platform that sells appreciating right or ownership right.

A secondary object of the invention is to use a third-party authentication mechanism to enable an identity authentication information (identity certificate or related certificates of the physical object) of the physical object and the master private key corresponding to the physical object to sign jointly, thereby ensuring that a source of the physical object is authentic and not fake and an uniqueness of the 3D image file of the physical object in order to enhance the trust of bidders.

In order to achieve the above objects, the invention is a solid modeling and non-fungible virtual and anti-counterfeiting integration system comprising a 3D modeling device for three-dimensional construction of at least one physical object to obtain a 3D image file with a characteristic value; an elliptic curve cryptographic module for generating at least one sub-public key capable of encrypting the characteristic value of the 3D image file and at least one sub-private key capable of decrypting the sub-public key to restore the characteristic value and display the 3D image file; and a non-fungible transaction platform comprising at least one master private key capable of signing the sub-public key and the sub-private key, and a master public key, the master public key verifies the signature, by obtaining the sub-public key and the sub-private key, the sub-private key is capable of decrypting the sub-public key to restore the characteristic value and display the 3D image file.

According to one embodiment of the invention, wherein the non-fungible transaction platform further has a third-party authentication module for importing an identity authentication information corresponding with the physical object, and the identity authentication information of the physical object and the master private key corresponding to the physical object sign jointly.

According to one embodiment of the invention, the non-fungible transaction platform further establishes a membership module, and according to an account and a password set up by the membership module, the sub-private key is capable of directly decrypting the sub-public key to restore the characteristic value and display the 3D image file through a mobile phone or a 3D projection device.

According to one embodiment of the invention, further comprising an external hardware device for storing the sub-private key and the master public key, the master public key verifying the signature, and the sub-private key decrypting the sub-public key to restore the characteristic value and display the 3D image file through the external hardware device.

According to one embodiment of the invention, wherein there are a plurality of the sub-private keys, and the same sub-public key is decrypted by the sub-private keys to restore the characteristic value and display the 3D image file.

### BRIEF DESCRIPTION OF THE DRAWINGS

FIG. 1 is a flow chart of encryption and decryption performed by an elliptic curve cryptographic module in collaboration with a 3D modeling device of the invention;

FIG. 2 is a flow chart of signing and verifying performed by a non-fungible transaction platform of the invention;

FIG. 3 is a flow chart of adding a third-party authentication module to the invention;

FIG. 4 is a flow chart of adding a membership module to the invention; and

FIG. 5 is a flow chart of adding an external hardware device to the invention.

### DETAILED DESCRIPTION OF THE INVENTION

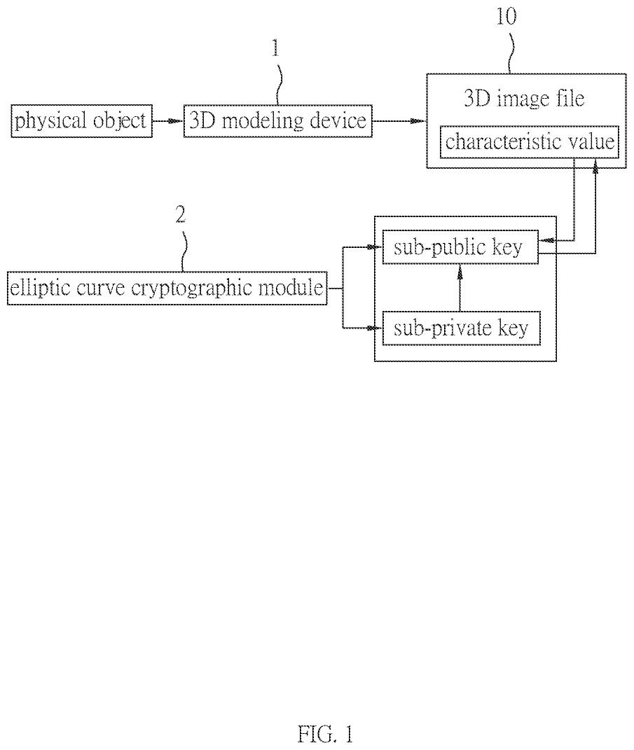

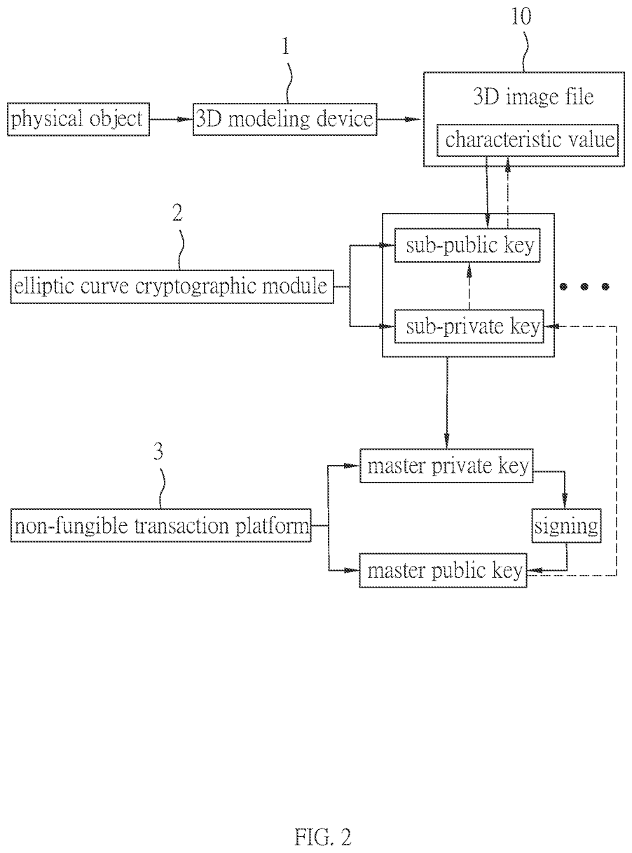

Please refer to FIG. 1 and FIG. 2 respectively for a flow chart of encryption and decryption performed by an elliptic curve cryptographic module in collaboration with a 3D modeling device; and a flow chart of signing and verifying performed by a non-fungible transaction platform of the invention. The invention is a solid modeling and non-fungible virtual and anti-counterfeiting integration system mainly comprising a 3D modeling device 1, an elliptic curve cryptographic (ECC) module 2, and a non-fungible transaction platform 3, wherein the 3D modeling device 1 obtains a 3D image file 10 with a characteristic value by constructing three-dimensionally from a physical object. The so-called physical object in the invention is mainly an object with high economic value, such as antiques, artworks or collectibles, and the characteristic value is taken out from an original data of the physical object obtained by shooting with a 3D camera. The so-called characteristic value is mainly lines or light in the original data used to form an appearance. At present, a process of the 3D modeling device 1 modeling the physical object mainly comprises: hardware, acquisition, calibration, registration, 3D reconstruction, and security. Wherein the hardware is mainly a light field sensor with a specific movement path; the acquisition is carried out by collecting images of viewpoints using a miniature camera; calculating the images of viewpoints using a perspective camera and with a calibration method; the registration is the iterative closest point (ICP) operation of different viewing angles, the so-called ICP refers to the relatively small change in poses between two adjacent frames, when solving the variables, the pose of the previous frame is used directly for initialization, in short, iterate to the nearest point; and then enter a 3D reconstruction and security stage, merge grids with images through 3D reconstruction, and then add watermark or asymmetric cryptographic key encryption through security.

After the 3D modeling device 1 has obtained the characteristic value of the physical object, the characteristic value is encrypted or decrypted by the elliptic curve cryptographic module 2. The elliptic curve cryptographic module 2 has a sub-public key and a sub-private key. Wherein the sub-public key mainly encrypts the characteristic value of the 3D image file 10, that is, a single physical object can correspond to the single sub-public key or a plurality of the sub-public keys. The sub-private key decrypts the sub-public key to restore the characteristic value and display the 3D image file 10. There can be the single sub-private key or a plurality of the sub-private keys, the sub-private key is mainly regarded as an appreciating right to view the 3D image file 10 of the physical object. Therefore, the more appreciating rights being released, a quantity of the sub-private key increases correspondingly, for example, there are 10 sets of the sub-private keys.

The non-fungible transaction platform 3 comprises a master private key and a master public key. Wherein the master private key mainly signs the sub-public key and the sub-private key, that is, a single appreciating right will have one set of the sub-private key and the sub-public key, in other words, as a quantity of appreciating right increases, a quantity of the sub-private key and the sub-public key increases correspondingly. The master private key is capable of signing multiple sets of the sub-private keys and the sub-public keys, the master public key verifies a completed signature, and the sub-public key and the sub-private key can be obtained after verification is passed. At this time, the sub-private key can be used to decrypt the sub-public key to restore the characteristic value and display the 3D image file 10. Dotted lines in the figures represent the sub-public key being decrypted by the sub-private key after signature verification to restore the characteristic value and display the 3D image file 10.

It can be known from the above that potential owners of the physical object (antiques, artworks or collectibles, etc.) with high economic value are capable of bidding on an appreciating right of the physical object through the non-fungible transaction platform 3; the physical object is three-dimensionally constructed with the 3D modeling device 1 to obtain the 3D image file 10 with the characteristic value before the physical object is listed on the non-fungible transaction platform 3. As mentioned above, the elliptic curve cryptographic module 2 is capable of adding multiple sets of the sub-private keys and the sub-public keys to the characteristic value. After the elliptic curve cryptographic module 2 has added 10 sets of the sub-private keys and the sub-public keys, it means that 10 persons are capable of obtaining the appreciating right of the 3D image file 10 of the physical object, and the master private key and the master public key in the non-fungible transaction platform 3 are mainly used to sign and verify 10 sets of the sub-private keys and the sub-public keys to achieve anti-counterfeiting and ensure security.

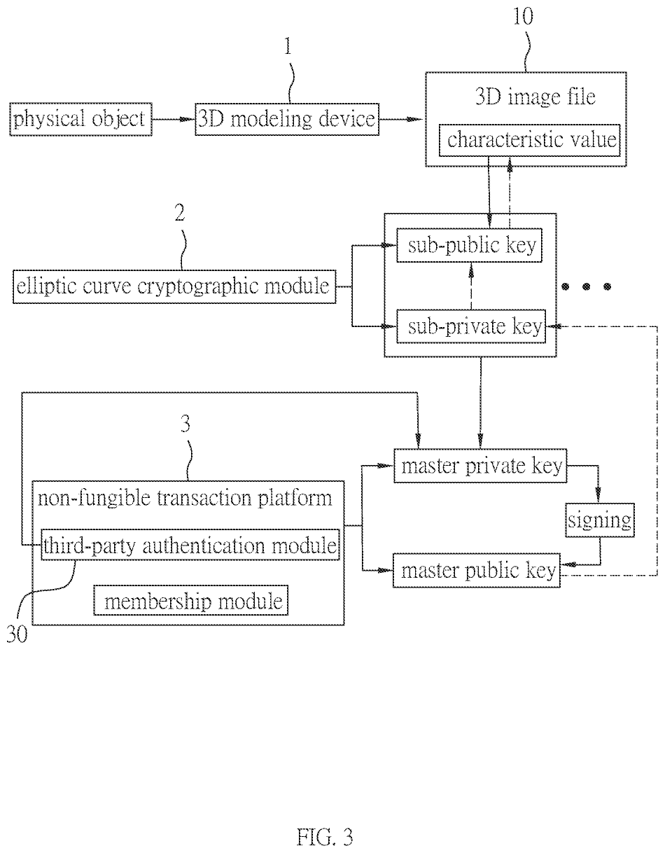

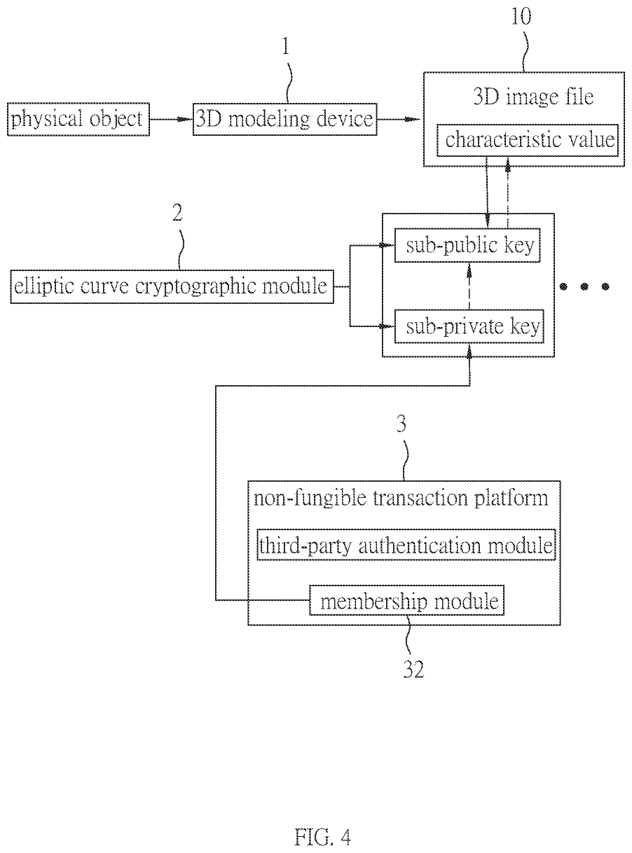

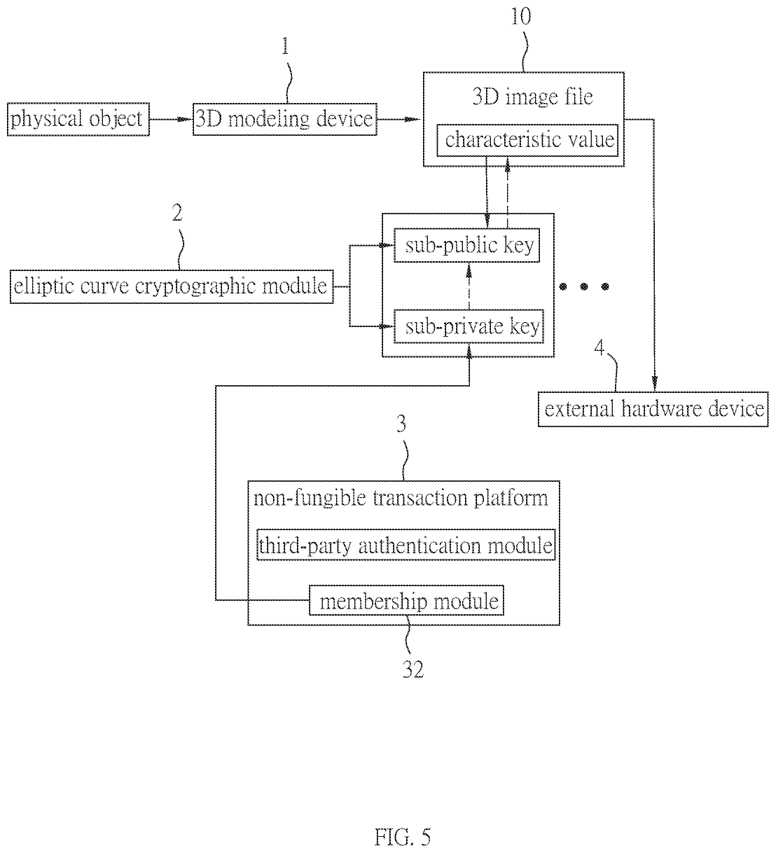

Please refer to FIGS. 3, 4, and 5 respectively for a flow chart of adding a third-party authentication module to the invention; a flow chart of adding a membership module to the invention; and a flow chart of adding an external hardware device to the invention. It can be known from the figures that the non-fungible transaction platform 3 further has a third-party authentication module 30 for importing an identity authentication information corresponding with the physical object, and the identity authentication information of the physical object and the master private key corresponding to the physical object sign jointly. The identity authentication information is mainly the unique identity information of the physical object to ensure that the physical object is authentic and not fake.

In addition, the non-fungible transaction platform 3 is further established with a membership module 32, and according to accounts and passwords set up by the membership module 32 members successful in bidding the physical object are capable of directly decrypting the sub-public key with the sub-private key to restore the characteristic value and display the 3D image file 10, so that the members are capable of quickly and securely displaying the 3D image file 10 directly.

Furthermore, the 3D image file 10 can be directly displayed by an external hardware device 4 (which can be any electronic device that displays 3D images), wherein the external hardware device 4 is provided for storing the sub-private key and the master public key, the signature is verified by the master public key, and the sub-private key decrypts the sub-public key to restore the characteristic value and display the 3D image file 10 through the external hardware device 4.

The complete mechanism of the invention from 3D modeling and encryption to non-fungible token (NFT) digital asset, and to 3D image file decryption and appreciating is not only capable of reducing the possibility of plagiarism and misappropriation, and through a non-fungible token (NFT) method, buyers can collect a digital copy of the physical object from the non-fungible transaction platform that sells appreciating right or ownership right.

The basic principles, main features and advantages of the invention have been shown and described above. Those skilled in the art should understand that the invention is not limited by the above-mentioned embodiments. Descriptions in the above-mentioned embodiments and specification merely illustrate the principles of the invention, without departing from the spirit and scope of the invention, the invention will have various changes and improvements, all these changes and improvements shall fall within the scope of protection of the invention, and the scope of protection of the invention is defined by the appended claims and their equivalents.

What is claimed is:

1. A solid modeling and non-fungible virtual and anti-counterfeiting integration system comprising:
a 3D modeling device for three-dimensional construction of at least one physical object to obtain a 3D image file with a characteristic value;
an elliptic curve cryptographic module for generating at least one sub-public key capable of encrypting the characteristic value of the 3D image file and at least one sub-private key capable of decrypting the sub-public key to restore the characteristic value and display the 3D image file; and
a non-fungible transaction platform comprising at least one master private key capable of signing the sub-public key and the sub-private key, and a master public key, the master public key verifying the signature, by obtaining the sub-public key and the sub-private key, the sub-private key being capable of decrypting the sub-public key to restore the characteristic value and display the 3D image file.

2. The solid modeling and non-fungible virtual and anti-counterfeiting integration system as claimed in claim 1, wherein the non-fungible transaction platform further has a third-party authentication module for importing an identity authentication information corresponding with the physical object, and the identity authentication information of the physical object and the master private key corresponding to the physical object sign jointly.

3. The solid modeling and non-fungible virtual and anti-counterfeiting integration system as claimed in claim 1, the non-fungible transaction platform further establishing a membership module, and according to an account and a password set up by the membership module, the sub-private key being capable of directly decrypting the sub-public key to restore the characteristic value and display the 3D image file.

4. The solid modeling and non-fungible virtual and anti-counterfeiting integration system as claimed in claim 1, further comprising an external hardware device for storing the sub-private key and the master public key, the master public key verifying the signature, and the sub-private key decrypting the sub-public key to restore the characteristic value and display the 3D image file through the external hardware device.

5. The solid modeling and non-fungible virtual and anti-counterfeiting integration system as claimed in claim 1, wherein there are a plurality of the sub-private keys, and the same sub-public key is decrypted by the sub-private keys to restore the characteristic value and display the 3D image file.
